(19) United States
(12) Patent Application Publication
(10) Pub. No.: US 2018/0045109 A1
(43) Pub. Date: Feb. 15, 2018

(54) ENGINE INTAKE AND EXHAUST FLOW MANAGEMENT

(71) Applicant: EATON CORPORATION, Cleveland, OH (US)

(72) Inventors: Matthew James FORTINI, Livonia, MI (US); Sean Paul KEIDEL, Royal Oak, MI (US); Vasilios TSOURAPAS, Northville, MI (US)

(73) Assignee: EATON CORPORATION, Cleveland, OH (US)

(21) Appl. No.: 15/551,454

(22) PCT Filed: Feb. 15, 2016
(86) PCT No.: PCT/US16/17978

§ 371 Date: Aug. 16, 2017

Related U.S. Application Data
(60) Provisional application No. 62/116,666, filed on Feb. 16, 2015.

(51) Int. Cl. F02B 39/10; F02D 41/00

(52) U.S. Cl. CPC F02B 39/10; F02D 41/0007; F02D 41/0087; F02B 2037/122

(57) ABSTRACT

An engine system including a power plant, an intake assist device connected to an air inlet of the power plant, and an expander connected to an exhaust outlet of the power plant is presented. A motor/generator is connected to power the expander to selectively provide power to and capture power from the expander. An expander controller is connected to control the motor/generator connection to the expander, and is configured to select between a passive mode, where exhaust passively moves through the expander, and an active mode, where the motor/generator powers the expander to actively draw exhaust from the exhaust manifold. In one example, the air intake and exhaust flows are controlled independently of the rotational speed of the power plant.

### CROSS-REFERENCE TO RELATED APPLICATION

This application claims the benefit of U.S. Provisional Patent Application Ser. No. 62/116,666, filed on Feb. 16, 2015, the entirety of which is incorporated by reference herein.

### GOVERNMENT LICENSE RIGHTS

This invention was made with government support under DE-EE0006844 awarded by the United States Department of Energy. The government has certain rights in the invention.

### TECHNICAL FIELD

This application relates to engine systems. More specifically, the application provides a systems and methods for engine intake and exhaust flow management.

### BACKGROUND

Turbocharged gasoline engines can experience knock at low engine speeds when the turbocharger is not operating in an ideal speed range. When the engine is also cold, or warming up, the knock is hard to combat because the turbocharger is not receiving the heat and mass flow necessary to spool up. A back pressure results between the engine intake and exhaust. The improper air to fuel ratio promoted by the back pressure causes the knock. Turbocharged diesel engines can experience lag and engine performance issues at lower engine speeds and during transient events when the turbocharger is not operating in an ideal speed range and high levels of EGR is being utilized.

One solution to correct the turbocharger challenge involves opening the exhaust valve before the compression stroke reaches bottom dead center (BDC). While this gives the exhaust more time to clear the cylinder before the next combustion cycle intakes air, the stroke reduction also reduces engine power output. Limiting boost by opening a waste gate is another commonly implemented countermeasure to address the above identified issues. However, this approach results in reduced engine power output and non-optimized engine performance/waste heat recovery.

### SUMMARY

The methods and devices presented herein overcome the above disadvantages and improves the art by way of engine intake and exhaust flow management. The invention enables control of the intake and exhaust of the engine independent of the engine speed. Computer control of one or both of an intake assist device and an expander enhances engine cylinder scavenging of exhaust, reduces engine knock, improves drivability, and optimizes fuel use.

In one example, a power generation system is presented including a power plant having a crankshaft, an air intake system, and an exhaust outlet. The expander can include a pair of symmetric rotors in fluid communication with the exhaust outlet and a drive shaft operably connected to one of the rotors. A motor/generator coupled to the expander drive shaft can also be provided. A controller is also provided that is connected to control the power plant air intake system, the motor/generator, the controller being configured to operate the motor/generator and the air intake system such that an air intake flow into the power plant and an exhaust air flow out of the power plant are controlled independently of a rotational speed of the power plant crankshaft.

In one example, an engine system comprises an engine comprising an inlet manifold, an exhaust manifold, and a plurality of combustion cylinders, and each of the plurality of combustion cylinders is connected to receive air from the inlet manifold and to expel exhaust from the exhaust manifold. Intake valves regulate air flow from the inlet manifold in to a respective one of each of the plurality of combustion cylinders. Exhaust valves regulate exhaust flow from a respective one of each of the plurality of combustion cylinders in to the exhaust manifold. Pistons in each of the plurality of combustion cylinders are connected to the engine to travel in its respective cylinder from top dead center to bottom dead center to complete a combustion cycle. A variable valve timing controller is connected to the respective intake valves and to the respective exhaust valves to control the timing of each of the plurality of combustion cylinders for receiving air from the inlet manifold and to control the timing for each of the plurality of combustion cylinders for expelling exhaust to the exhaust manifold. A fuel injection system is connected to supply fuel to each of the plurality of combustion cylinders. A expander is connected to receive exhaust from the exhaust manifold. A motor/generator is connected to power the expander. An expander controller is connected to control the motor/generator connection to the expander, and the expander controller is configured to select between a passive mode, where exhaust passively moves through the expander, and an active mode, where the motor/generator powers the expander to actively draw exhaust from the exhaust manifold. Moreover, the motor/generator and associated controller allow for the expander to be operated as a compressor and/or expander in the exhaust system in addition to the previously disclosed function.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 is a perspective view of a power generation system, which is an example in accordance with aspects of the invention.

FIG. 2 is a side view of the power generation system shown in FIG. 1.

FIG. 3 is a perspective view of an expander and motor/generator of the power generation system shown in FIG. 1.

FIG. 4 is a side view of the expander and motor/generator shown in FIG. 3.

FIG. 5 is a perspective view of an expander, exhaust bypass assembly, and exhaust manifold of the power generation system shown in FIG. 1.

FIG. 6 is a side view of the expander, exhaust bypass assembly, and exhaust manifold shown in FIG. 5.

FIG. 7 is a schematic of the power generation system shown in FIG. 1 connecting an engine cylinder to controllers.

FIG. 8 is a schematic of a computer controller configured to operate the power generation system shown in FIG. 1.

FIG. 9 is a schematic of a modified version of the power generation system shown in FIG. 1, wherein an intake assist device and exhaust gas recirculation system are additionally provided.

FIG. 10 is a schematic of a modified version of the power generation system shown in FIG. 9, wherein a turbocharger is additionally provided.

FIG. 11 is a schematic side view of an expander usable in the power generation system shown in FIG. 1.

FIG. 12 is a schematic perspective view of the expander shown in FIG. 11.

### DETAILED DESCRIPTION

Reference will now be made in detail to the examples which are illustrated in the accompanying drawings. Wherever possible, the same reference numbers will be used throughout the drawings to refer to the same or like parts. Directional references such as “left” and “right” are for ease of reference to the figures.

### Volumetric Energy Recovery Device (Expander)

In the disclosed systems, a volumetric energy recovery device or expander 20 is shown and described. While some details of the expander 20 are discussed in this subsection, additional structural and operational aspects can be found in Patent Cooperation Treaty (PCT) International Publication Number WO 2014/144701 and in United States Patent Application Publication US 2014/0260245, the entireties of which are incorporated herein by reference.

In general, the volumetric energy recovery device or expander 20 relies upon the kinetic energy and static pressure of a working fluid to rotate an output shaft 38. The expander 20 may be an energy recovery device 20 wherein the working fluid 12-1 is the direct engine exhaust from the engine. In such instances, device 20 may be referred to as an expander or expander, as so presented in the following paragraphs.

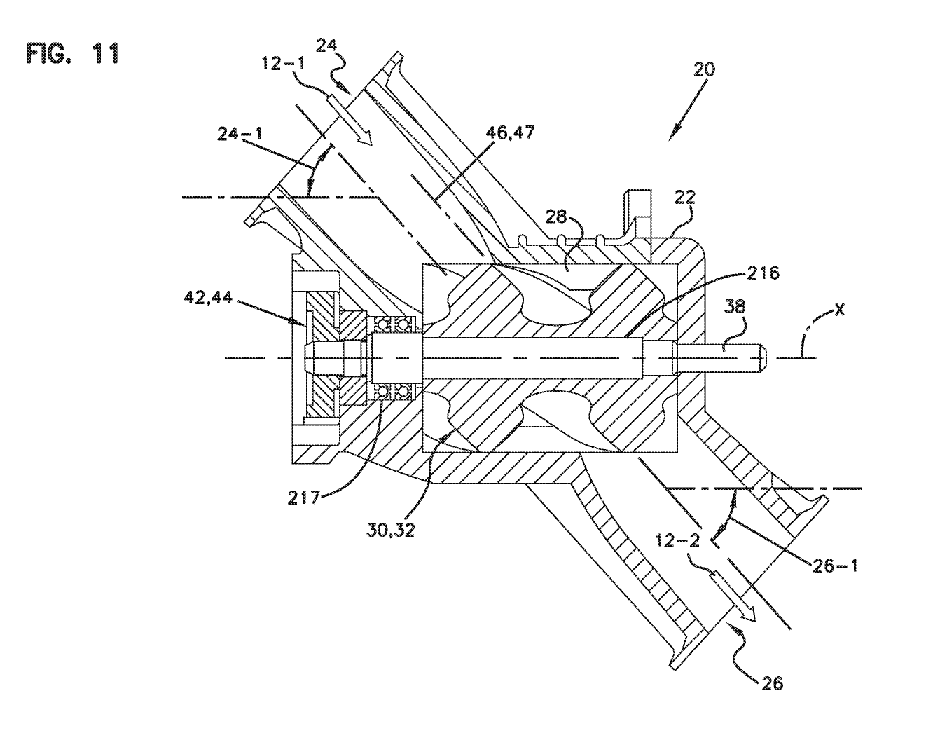

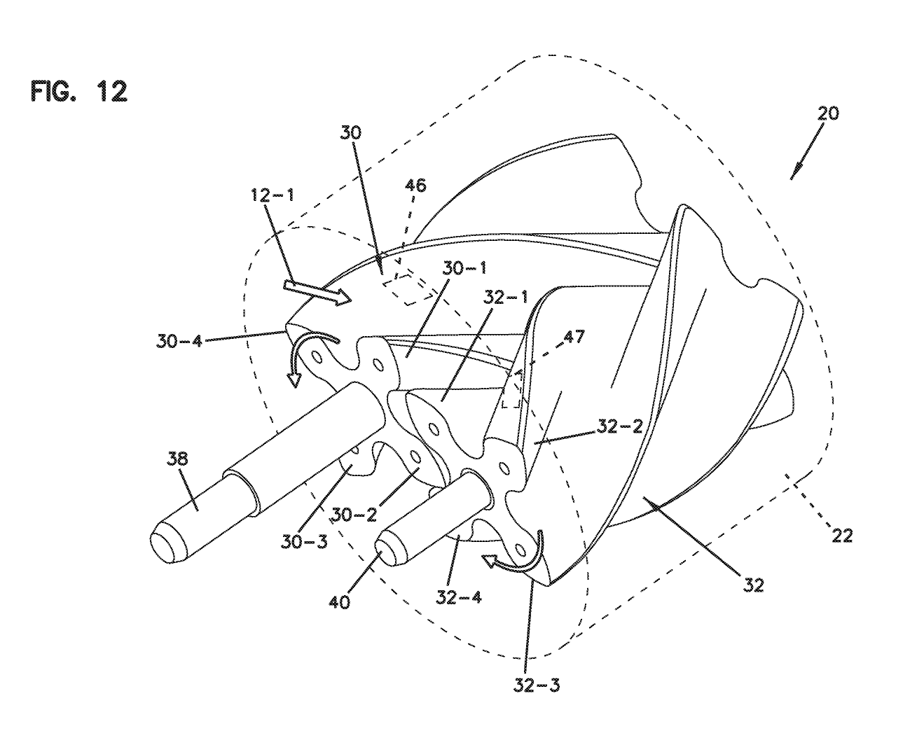

With reference to FIGS. 11 and 12, it can be seen that the expander 20 has a housing 22 with a fluid inlet 24 and a fluid outlet 26 through which the working fluid 12-1 undergoes a pressure drop to transfer energy to the output shaft 38. The output shaft 38 is driven by synchronously connected first and second interleaved counter-rotating rotors 30, 32 which are disposed in a cavity 28 of the housing 22. Each of the rotors 30, 32 has lobes that are twisted or helically disposed along the length of the rotors 30, 32. Upon rotation of the rotors 30, 32, the lobes at least partially seal the working fluid 12-1 against an interior side of the housing at which point expansion of the working fluid 12-1 only occurs to the extent allowed by leakage which represents and inefficiency in the system. In contrast to some expanders that change the volume of the working fluid when the fluid is sealed, the volume defined between the lobes and the interior side of the housing 22 of device 20 is constant as the working fluid 12-1 traverses the length of the rotors 30, 32. Accordingly, the expander 20 may be referred to as a “volumetric device” as the sealed or partially sealed working fluid volume does not change.

In the particular example shown at FIGS. 11 and 12, the expander 20 inlets and outlets are configured for use with a relatively low pressure working fluid, such as exhaust from an internal combustion engine or fuel cell. However, the following description is generally applicable for use with any type of a working fluid. The expander 20 includes a housing 22. As shown in FIG. 11, the housing 22 includes an inlet port 24 configured to admit relatively high-pressure working fluid 12-1 from the heat exchanger 18 (shown in FIG. 12). The housing 22 also includes an outlet port 26 configured to discharge working fluid 12-2 to the condenser 14 (shown in FIG. 12). It is noted that the working fluid discharging from the outlet 26 is at a relatively higher pressure than the pressure of the working fluid at the condenser 14.

As additionally shown in FIG. 12, each rotor 30, 32 has four lobes, 30-1, 30-2, 30-3, and 30-4 in the case of the rotor 30, and 32-1, 32-2, 32-3, and 32-4 in the case of the rotor 32. Although four lobes are shown for each rotor 30 and 32, each of the two rotors may have any number of lobes that is equal to or greater than two, as long as the number of lobes is the same for both rotors, thereby resulting in symmetric rotors. Accordingly, when one lobe of the rotor 30, such as the lobe 30-1 is leading with respect to the inlet port 24, a lobe of the rotor 32, such as the lobe 30-2, is trailing with respect to the inlet port 24, and, therefore with respect to a stream of the high-pressure working fluid 12-1.

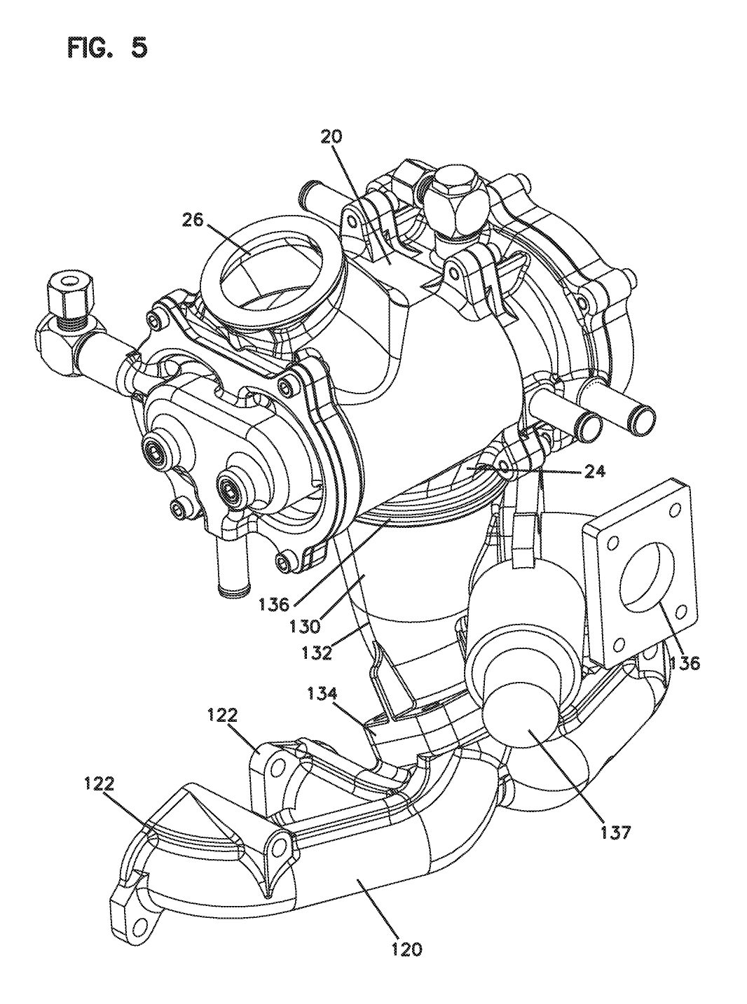

As shown, the first and second rotors 30 and 32 are fixed to respective rotor shafts, the first rotor being fixed to an output shaft 38 and the second rotor being fixed to a shaft 40. Each of the rotor shafts 38, 40 is mounted for rotation on a set of bearings (not shown) about an axis X1, X2, respectively. It is noted that axes X1 and X2 are generally parallel to each other. The first and second rotors 30 and 32 are interleaved and continuously meshed for unitary rotation with each other. With renewed reference to FIG. 5, the expander 20 also includes meshed timing gears 42 and 44, wherein the timing gear 42 is fixed for rotation with the rotor 30, while the timing gear 44 is fixed for rotation with the rotor 32. The timing gears 42, 44 are configured to retain specified position of the rotors 30, 32 and prevent contact between the rotors during operation of the expander 20.

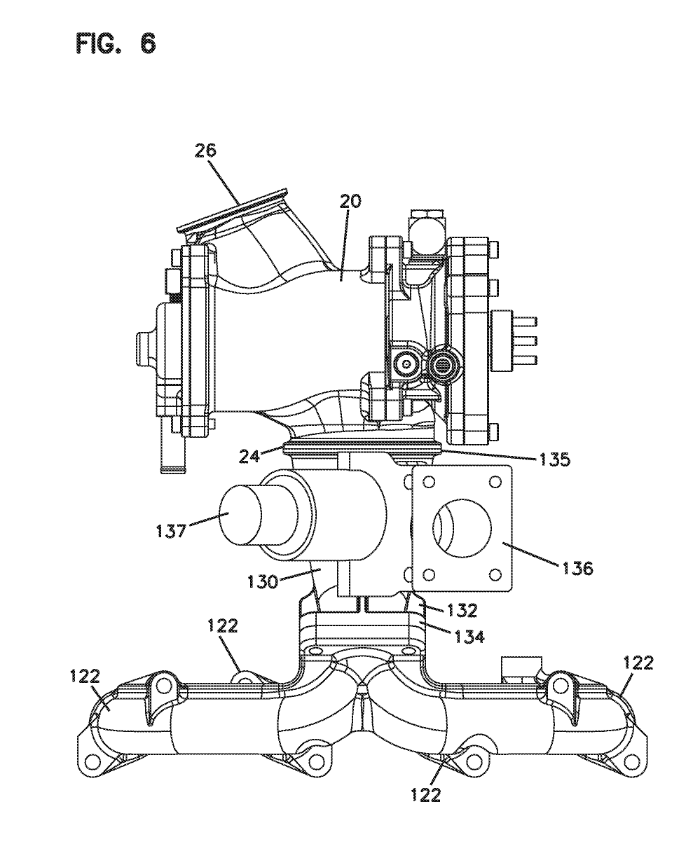

The output shaft 38 is rotated by the working fluid 12 as the working fluid undergoes expansion from the relatively high-pressure working fluid 12-1 to the relatively low-pressure working fluid 12-2. As may additionally be seen in both FIGS. 5 and 6, the output shaft 38 extends beyond the boundary of the housing 22. Accordingly, the output shaft 38 is configured to capture the work or power generated by the expander 20 during the expansion of the working fluid 12 that takes place in the rotor cavity 28 between the inlet port 24 and the outlet port 26 and transfer such work as output torque from the expander 20. Although the output shaft 38 is shown as being operatively connected to the first rotor 30, in the alternative the output shaft 38 may be operatively connected to the second rotor 32.

In one aspect, the expander 20 can also be operated as a high volumetric efficiency positive displacement pump when driven by a motor/generator, such as a motor/generator 70, as discussed in further detail below.

### General System Architecture

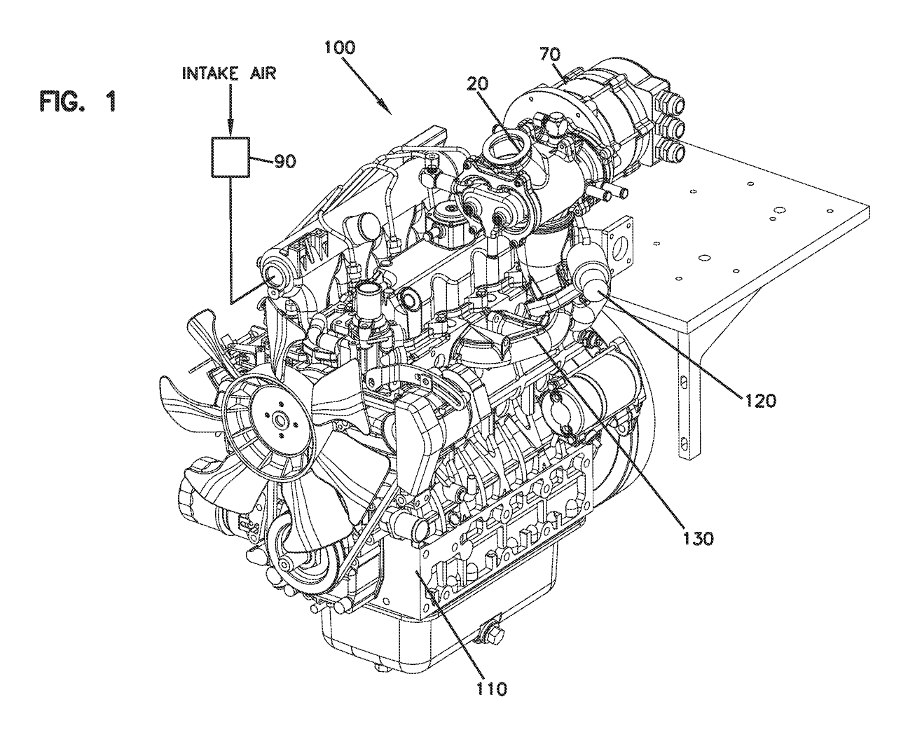

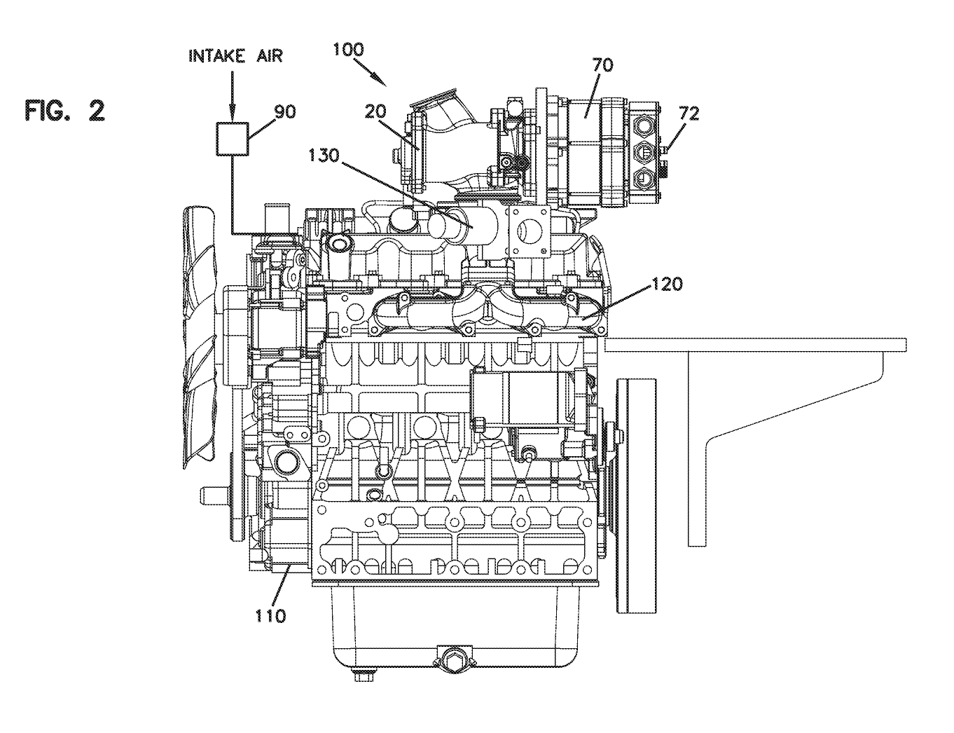

With reference to FIGS. 1 and 2, a power generation system or engine system 100 is shown. The power generation system 100 can include a power plant 110, for example an internal combustion engine or a fuel cell. In the example shown, the power plant 110 has an exhaust manifold 120 for receiving exhaust gases from the power plant 110. An exhaust bypass assembly 130 is shown as being mounted to the exhaust manifold 120 while the expander 20 is shown as being mounted to the bypass assembly 130. Accordingly, any fraction of exhaust from the power plant 110 can be selectively directed by the bypass assembly 130 through or around the expander 20. The expander 20 is also shown as being coupled to the motor/generator 70 in FIGS. 1 and 2, wherein the output shaft 38 of the expander 20 is coupled to a drive shaft 72 of the motor/generator 70.

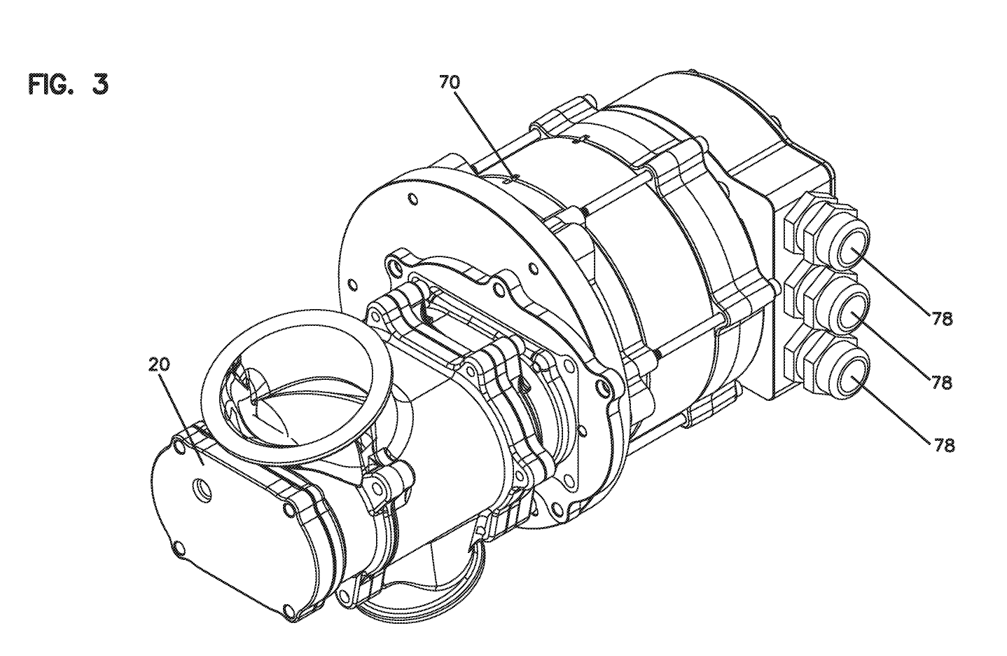

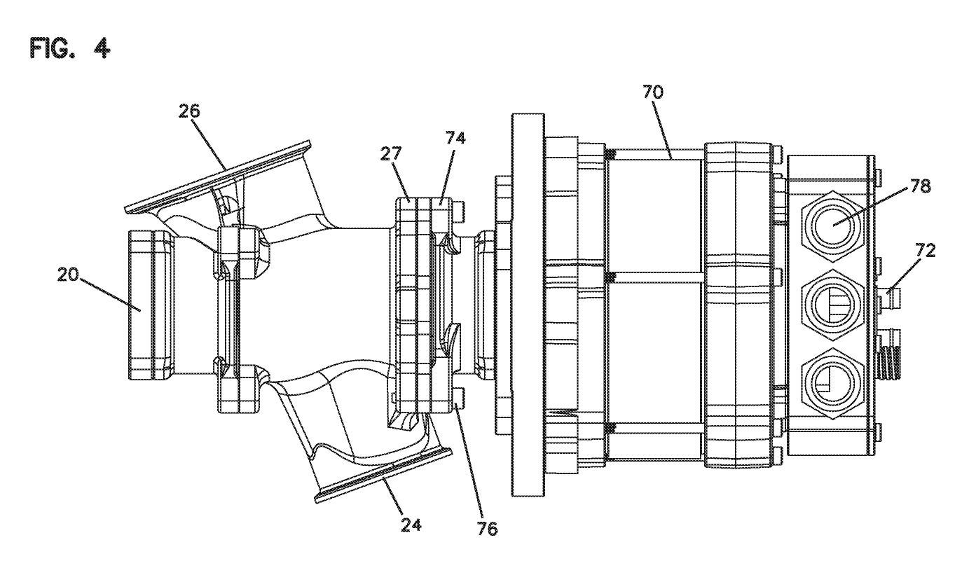

With reference to FIGS. 3 and 4, the expander 20 and motor/generator 70 are shown in isolation from the power generation system 100. As shown, the motor/generator 70 can be provided with a mounting flange 74 configured to mate against a corresponding mounting flange 27 of the expander 20. The expander 20 and the motor/generator 70 can be secured together at the flanges 27, 74 via mechanical fasteners, such as bolts or screws 76. The motor/generator 70 is also shown with ports 78 from which electrical leads can extend, for example to a battery.

With reference to FIGS. 5 and 6, the expander 20, the exhaust bypass assembly 130, and the exhaust manifold 120 are shown in isolation from the power generation system 100. As shown, the exhaust manifold 120 is configured with four inlet ports 122 for receiving exhaust gases from a four cylinder engine. However, it should be understood that the any number of cylinders for the engine and corresponding ports 122 may be provided. The exhaust bypass assembly 130 is provided with a main body 132 having an inlet 133, a first outlet 135, and a second outlet 136. As shown, a valve arrangement and actuator 137 is provided in the second outlet 136 to allow at least some of the exhaust gases to bypass around the expander. In an alternative configuration, the valve arrangement can be provided as a three-way valve to selectively direct exhaust air from the inlet 133 to either or both of the first and second outlets 135, 136 in any desired ratio between all of the exhaust gases being directed to the first outlet 135 and all of the exhaust gases being directed to the second outlet 136. The first outlet 135 is shown as being in fluid communication with the inlet 24 of the expander 20. The second outlet 136 can be coupled to another downstream device, such as a turbocharger, or can be more simply directed to the exhaust outlet of the power plant 110. In the example shown, the exhaust bypass assembly 130, the manifold 120, and the expander 20 are provided with mounting flanges that can be mated and bolted together. Gaskets and/or seals can be provided to ensure the exhaust gases do not leak or otherwise escape as they pass from one component to the other.

### Operational Configurations

FIG. 4 illustrates one cylinder 140 of the power plant 110, when the power plant 110 is configured as a multi-cylinder engine. For example, the engine can comprise 2, 3, 4, 6, 8 or more cylinders. The cylinders 140 can be laid out in various configurations, such as in-line, V, or horizontally opposed. In the example presented, diesel combustion is shown, and so a fuel injector 142 direct injects fuel between an air intake valve 144 and an exhaust valve 146. A piston 148 is connected to a crankshaft 150 of the power plant 110 via a connecting rod 152.

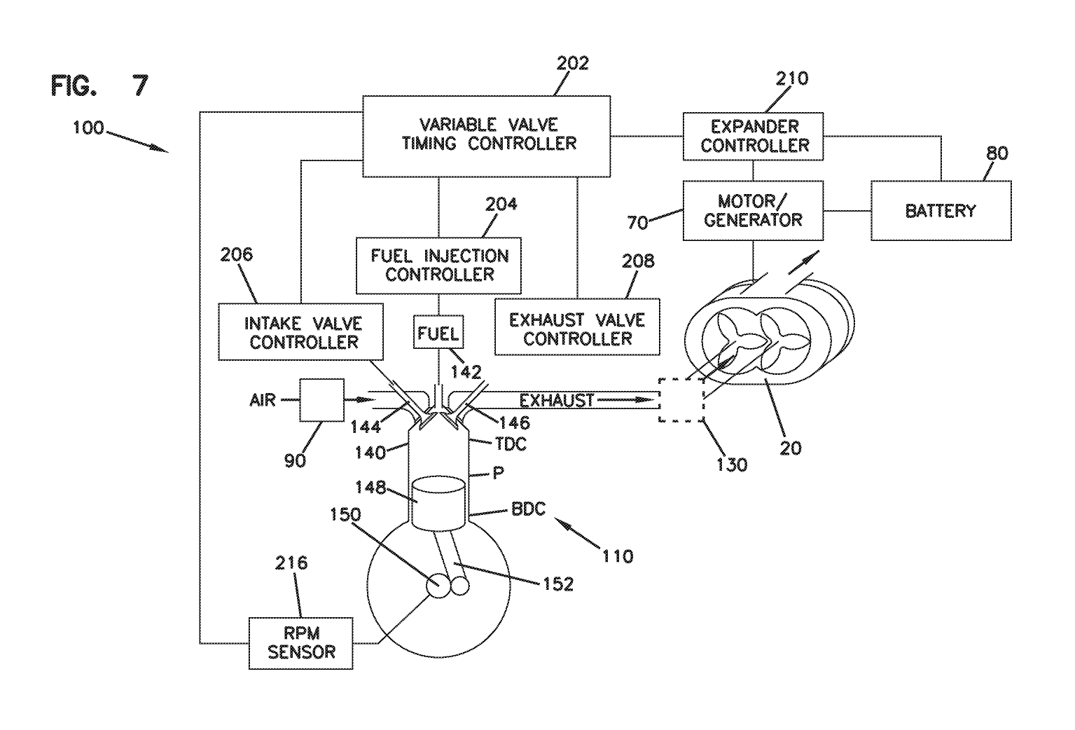

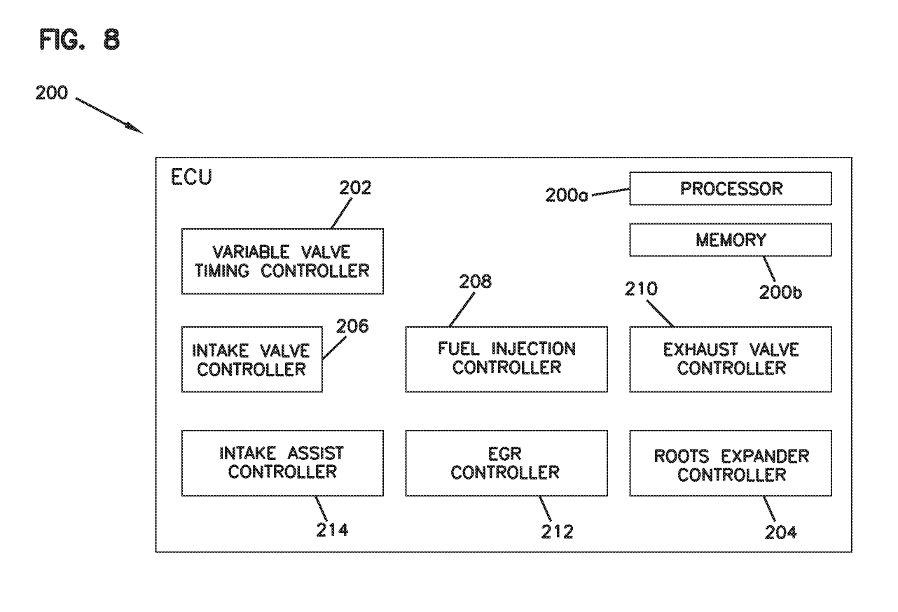

Still referring to FIG. 7, and also to FIG. 8, appropriate computer control hardware, such as an on-board chip, Electrical Control Unit 200, or dedicated variable valve timing controller 202 collects data on engine operating parameters, such as the speed of the engine crankshaft, valve location, piston location, operational status of the expander, etc. A central computing device can comprise allocation programming or multiple computing devices can send and receive data for processing. One or more processors process the data. One or more tangible memory devices store programming to execute algorithms necessary to implement a control strategy. RAM, ROM, or other memory devices can be used to store temporary data for operation on by the processor.

In the illustration, the variable valve timing controller 202 collects optional data from the crankshaft to determine the rotations per minute (RPMs) and rotational location of the crankshaft. Other optional data can include, for example, accelerator pedal location, throttle valve location, turbocharger speed, engine temperature, air temperature, exhaust temperature, etc. The collected data is used to determine the timing and quantity (pulse width) of fuel injection by a fuel injection controller 204, and the timing for opening and closing the intake valve 111 and exhaust valve 112 by an intake valve controller 206 and an exhaust valve controller 208, where provided. The data is also used to signal an expander controller 210 to power the motor/generator 70 to drive the expander 20 or to disconnect power for passive operation of the expander 20. Additional control can be included to divert passively generated energy from the expander 20 to, for example, drive the motor/generator 70 and charge a battery 80, augment crankshaft output, or power other system devices.

In one aspect, the expander 20 is coupled with the motor/generator 70 in the exhaust stream to improve engine scavenging. That is, the expander 20 is powered via the motor/generator 70 to positively displace exhaust flow, thereby scavenging exhaust out of the cylinder 140. This reduces engine knock at low engine speeds. By assisting with exhaust exit out of the cylinder 140, the variable valve timing controller 202 can adjust the exhaust valve timing to permit torque recovery for the full piston travel. The combustion stroke can be from top dead center TDC to bottom dead center BDC, even during low load or cold start conditions. Instead of opening the exhaust valve at time P, when the piston 148 has not travelled fully to bottom dead center BDC, the exhaust valve 146 opens at bottom dead center BDC. This operation can improve engine power output.

The expander 20 is able to scavenge the cylinder 140 independent of exhaust mass flow rate or engine speed, as measured at RPM sensor 216, because the expander 20 is coupled to and independently powered by the motor/generator 70. The expander 20 can be driven by the motor/generator 70 to impose a vacuum on the cylinder bore, which in turn reduces knock concerns and enables higher boost levels from the compressor 90. This results in improved drivability of the vehicle and fuel efficiency improvement through down speeding and downsizing. This also enables for a change in valve timing and knock mitigation strategies. When the assisted scavenging is not needed, such as when the engine 110 is operating at peak flow, the expander 20 can passively accept exhaust flow and transmit rotational energy back to the system, for example, by charging the battery 80 or via an input pulley mounted to the shaft 38 to the system FEAD (front end accessory drive) of the engine 110.

The expander 20 can also be operated at any engine speed to impose a vacuum on the cylinder 140 to remove the exhaust gasses. This gives the expander 20 a broad efficiency island to maintain expansion efficiency over a large engine operating range. This is in contrast to the operability of a turbocharger, which has a comparatively narrow operating range for peak efficiency. That is, the turbocharger is efficient for boosting the engine and for drawing exhaust in a narrow system operating range, but the expander 20 gives the system peak performance across a larger engine operating range. The expander 20 draws out the exhaust independently of the turbocharger action, the engine speed, and the engine temperature, because the expander can be linked with a motor/generator 70 that powers its positive displacement independently of these factors.

The fuel economy of the system is improved because the full combustion stroke is captured by the crankshaft 150, increasing torque output. The longer stroke at low operating range augments cylinder deactivation (CDA) opportunities by permitting more torque recovery per cylinder, extending the range to deactivate the other cylinders. And, when the activated cylinder, in CDA mode, experiences a higher pressure than the deactivated cylinders, the expander 20 assists with pressure relief by drawing the exhaust out.

And, because the exhaust is drawn out, the boost provided by the turbocharger is more effectively taken in to the cylinder 140 for the next combustion cycle, thus improving boost. The vacuum of exhaust by the expander 20 permits a higher amount of compressed air to enter the cylinder 140 on the next intake, decreasing the scavenging burden on the intake charge, decreasing the need to open the intake and exhaust valve 144, 146 at the same time, further decreasing chances of knock, all while increasing torque output. The result is provision of more low end torque and better drivability.

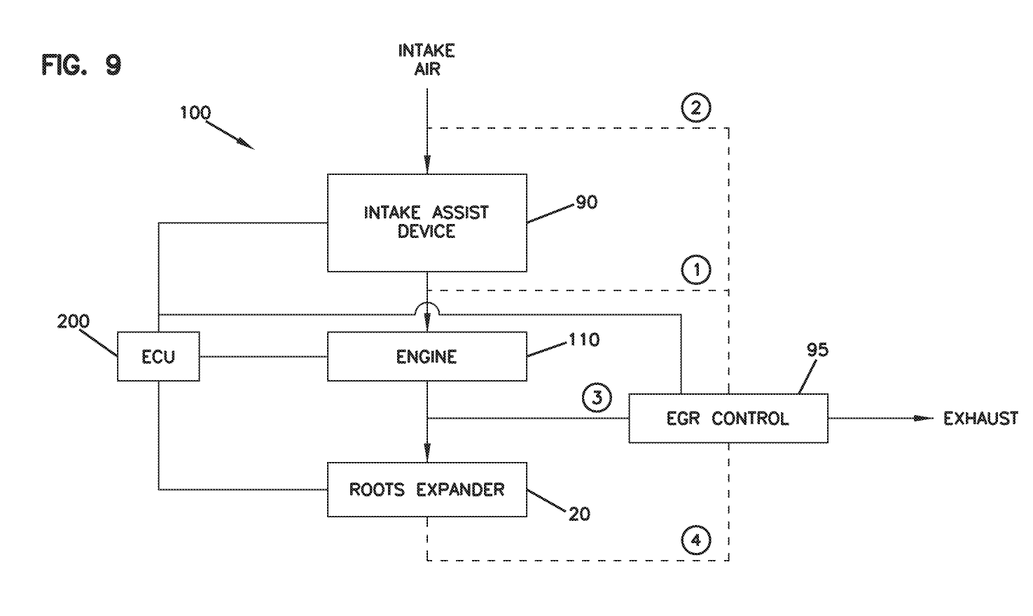

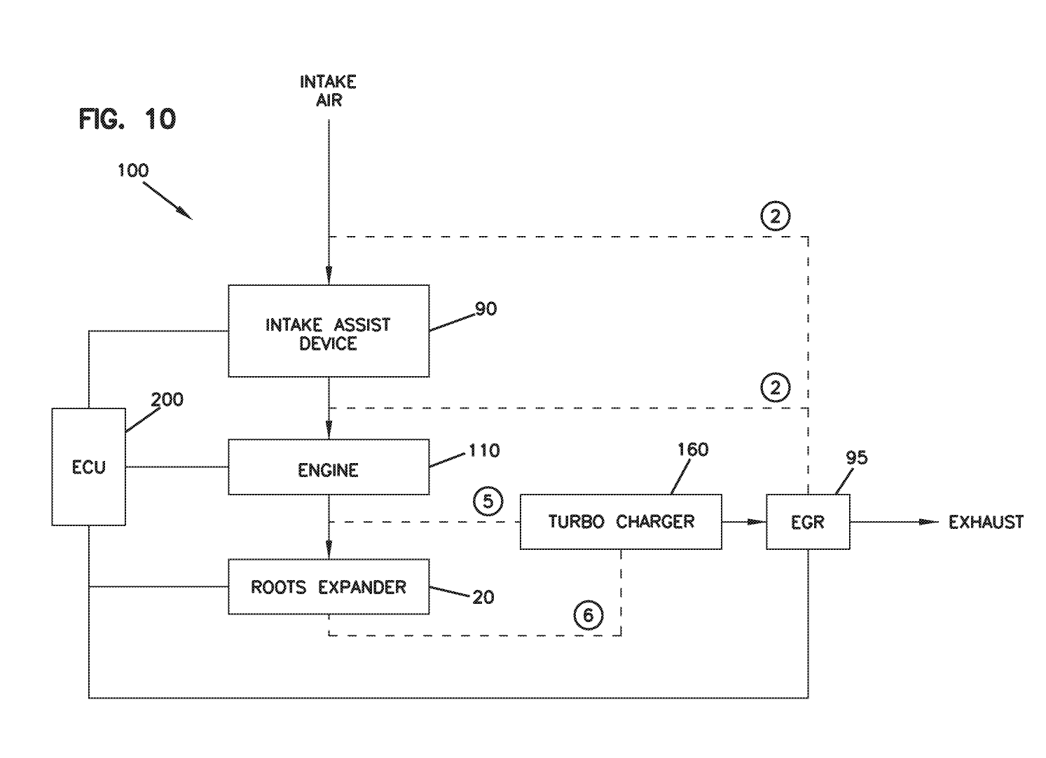

Various configurations of the disclosed system are shown at FIGS. 9 and 10. Comparing FIGS. 9 & 10, it is further possible to tailor the intake and the exhaust air flow by including an intake assist device 90 to provide additional air to the engine, while computer controlling the action of the expander. The intake assist device 90 is also shown at FIG. 7 and schematically at FIGS. 1 and 2. Exhaust gas recirculation (EGR) 95 can be added to further reduce engine knock and to recirculate exhaust. In some examples, the expander 20 is utilized as an EGR pump to help address transient response issues with high levels of engine exhaust (i.e. a high pressure EGR strategy) or to feed back the EGR to the inlet of the intake assist device 90 (i.e. a low pressure EGR strategy). While it is possible to include a turbocharger 160, it is also possible to eliminate the turbocharger 160 and use only an expander 20 at the outlet of the engine 110.

Boost can be provided by an intake air assist device 90, such as an electrically assisted variable speed (“EAVS”) supercharger, an electric boosting device such as a centrifugal compressor with an electric motor, or other boosting devices, such as a Roots-type, screw or scroll type supercharger, or an electrically assisted device with a planetary gear. Examples of EAVS superchargers usable in the disclosed system is shown and described at: U.S. Provisional patent application Ser. No. 11/776,834; U.S. Provisional Patent Application Ser. No. 61/776,837; U.S. Provisional Patent Application Ser. No. 62/133,038; PCT Application No. PCT/US2013/003094; and PCT Application No. PCT/US2015/11339, all of which are hereby incorporated by reference in their entireties.

The computer controller 200 shown at FIG. 8 can be used for the systems shown in FIGS. 9 & 10. An electronic control unit (ECU) 200 is an onboard computer control device comprising at least one processor 200a and tangible memory device 200b. Control logic is stored in the memory 200a and operated on by the processor 200b to implement computer control. Multiple discrete modules are shown in FIG. 8 and it is to be understood that the modules can be interconnected controllers, separate processors with affiliated storage and control logic, or the ECU 200 can comprise a central processor with allocation programming. The controllers, therefore, can be combined in to one or more processors or other communicating components such as integrated circuits. Various sensors can be utilized to collect data for processing.

Referring back to FIGS. 9 & 10, the intake assist device that is controlled along with the expander to optimize engine breathing. The intake assist device 90 can be computer-controlled to provide a precision air charge, and the expander 20 can be computer-controlled to draw out the exhaust for exhaust scavenging. The ECU 200 further controls the valve timing, for independent opening and closing of the intake and exhaust valves 144, 146. By controlling the intake flow and the outlet flow, it is possible to increase the compression ratio going to the cylinders 140. This helps control transient engine performance and mitigate knock.

One aspect of FIGS. 9 & 10 entails the EGR 95. The intake and exhaust control improves EGR operation by tailoring system pressure to draw and direct EGR gasses efficiently. The waste heat recovery performed by the expander 20 helps regulate exhaust pressure to enhance EGR. And, the intake assist device 90 also permits regulation of pressure and air flow to complement EGR efficiency.

FIG. 9 indicates along path 3 that exhaust can be directed from the engine 110 to an EGR control device 95, such as a computer controlled EGR valve. Exhaust can be selectively let out of the system, or directed back to the intake manifold. Path 1 directs EGR gasses to the intake side of the engine 110, for example, to the intake manifold or to a conduit connected to the outlet of the intake assist device. Path 2 directs EGR gasses to mix with fresh air and run through the intake assist device 90. Path 4 indicates that it is possible to collect exhaust gasses after the expander 20 for recirculation by the EGR 95 in lieu of Path 3. It is generally not practical to have all four paths in the same motive device, and so it is more likely that only paths 1 & 3, 1 & 4, 2 &, 3, or 2 & 4 would be used, as air handling and system pressures dictate. For example, in a system with low pressure EGR gas, it is possible to direct the EGR gas for recirculation along path 2, while a high pressure EGR gas preferably uses path 1. But, because of the possibility to bypass air with the exhaust bypass assembly 130, it is further possible to have a system with paths 2, 3 & 4 or paths 1, 3, & 4.

FIG. 10 indicates it is possible to include a turbocharger 160 for receiving exhaust along either one or both of paths 5 and 6. Computer control of the EGR 95 directs exhaust out of the system, or along paths 1 or 2. In lieu of a turbocharger 160, it is also possible to use the expander 20 to draw out the exhaust, as above, and to boost the intake using a supercharger 90. In one example, the output shaft 38 of the expander 20 is coupled to a planetary gear set which is also coupled to the motor/generator 70 and to an input shaft of the intake assist device 90. In such an example, the intake assist device 90 can be a centrifugal compressor, wherein either or both of the expander 20 (via power generated from the exhaust gases) and the motor/generator 70 can be utilized to drive the compressor. Aspects of such a configuration are described in Patent Cooperation Publication Number WO2014/144701, the entirety of which is incorporated by reference herein.

The expander 20 can be sized relative to the engine 110 such that the pumping losses, or energy drain on the system, are recuperated or overcompensated for, by the torque additions from the lengthened combustion stroke. That is, the expander 20 is a relatively small device with a low energy burden on the system. The energy burden can be comparable to that of an alternator.

Other implementations will be apparent to those skilled in the art from consideration of the specification and practice of the examples disclosed herein. It is intended that the specification and examples be considered as exemplary only, with the true scope of the invention being indicated by the following claims.

What is claimed is:

1. A power generation system, comprising:
a. a power plant having a crankshaft, an air intake system, and an exhaust outlet;
b. an expander including a pair of symmetric rotors in fluid communication with the exhaust outlet, the expander including a drive shaft operably connected to one of the rotors;
c. a motor/generator coupled to the expander drive shaft; and
d. a controller connected to control the power plant air intake system, the motor/generator, the controller being configured to operate the motor/generator and the air intake system such that an air intake flow into the power plant and an exhaust air flow out of the power plant are controlled independently of a rotational speed of the power plant crankshaft.

2. The power generation system of claim 1, wherein the air intake system includes an intake assist device.

3. The power generation system of claim 1, wherein the controller is configured to select between:
a. a passive mode, wherein the exhaust air flow passively moves through the expander to drive the motor/generator; and
b. an active mode, wherein the motor/generator powers the expander to impose a vacuum at the exhaust outlet to actively draw the exhaust air flow from the power plant.

4. The power generation system of claim 3, wherein the engine comprises a low power-output operating range, a high power-output operating range and an idle operating range, and the expander controller selects the active mode when the engine is transitioning from the idle operating range to the low power-output operating range.

5. The power generation system of claim 3, wherein the controller includes a variable valve timing control module that is configured to implement cylinder deactivation by deactivating a respective intake valve and a respective exhaust valve for at least one of a plurality of combustion cylinders associated with the power plant while completing the combustion cycle for the remainder of the plurality of combustion cylinders, and wherein the controller is configured to select the active mode when the variable valve timing controller implements cylinder deactivation.

6. The power generation system of claim 1, further comprising an exhaust gas recirculation control module in the controller for receiving exhaust from the engine, and coupled to return exhaust gas to the power plant intake system.

7. The power generation system of claim 2, further comprising an intake assist device comprising one of an electrically assisted variable speed (“EAVS”) supercharger, an electric boosting device, a centrifugal compressor with an electric motor, a Roots, screw or scroll type supercharger, or an electrically assisted device with a planetary gear.

8. The power generation system of claim 7, further comprising an exhaust gas recirculation control module in the controller for receiving the exhaust air flow from the power plant, and coupled to return exhaust gas upstream of an intake valve associated with the power plant, and downstream from the intake assist device.

9. The power generation system of claim 8, further comprising an exhaust gas recirculation control module in the controller for receiving exhaust from the engine, and coupled to return exhaust gas upstream of the intake assist device.

10. The power generation system of claim 8, further comprising an exhaust gas recirculation controller for receiving exhaust from the expander, and coupled to return exhaust gas upstream of the intake valve, and downstream from the intake assist device.

11. The power generation system of claim 8, further comprising an exhaust gas recirculation control module in the controller for receiving exhaust from the expander, and coupled to return exhaust gas upstream of the intake assist device.

12. The power generation system of claim 1, further comprising a turbocharger, wherein the turbocharger receives exhaust gas from the power plant prior to the exhaust gas recirculation controller.

13. An engine system, comprising:
an engine comprising an inlet manifold, an exhaust manifold, and a plurality of combustion cylinders, and each of the plurality of combustion cylinders is connected to receive air from the inlet manifold and to expel exhaust from the exhaust manifold;
a respective intake valve for regulating air flow from the inlet manifold in to a respective one of each of the plurality of combustion cylinders;
a respective exhaust valve for regulating exhaust flow from a respective one of each of the plurality of combustion cylinders in to the exhaust manifold;
a respective piston in each of the plurality of combustion cylinders, each respective piston connected to the engine to travel in its respective cylinder from top dead center to bottom dead center to complete a combustion cycle;
a variable valve timing controller connected to the respective intake valves and to the respective exhaust valves to control the timing of each of the plurality of combustion cylinders for receiving air from the inlet manifold and to control the timing for each of the plurality of combustion cylinders for expelling exhaust to the exhaust manifold;
a fuel injection system connected to supply fuel to each of the plurality of combustion cylinders;
a expander connected to receive exhaust from the exhaust manifold;
a motor/generator connected to power the expander; and
an expander controller connected to control the motor/generator connection to the expander, and the expander controller is configured to select between a passive mode, where exhaust passively moves through the expander, and an active mode, where the motor/generator powers the expander to actively draw exhaust from the exhaust manifold.

14. The engine system of claim 13, further comprising one of a battery powered motor or a generator as the motor/generator.

15. The engine system of claim 13, further comprising a turbocharger connected to receive exhaust from the expander and to supply boosted air to the inlet manifold.

16. The engine system of 14, wherein the expander is further coupled to charge the generator when in the passive mode.

17. The engine system of claim 1, wherein the combustion cycle comprises at least an intake stroke, a compression stroke, a combustion stroke and an exhaust stroke, and wherein the variable valve timing controller controls the timing of at least one intake valve and at least one exhaust valve for at least one of the plurality of combustion cylinders to remain fully closed from bottom dead center to top dead center of the compression stroke, and from top dead center to bottom dead center of the combustion stroke.

18. The engine system of claim 13 or 17, wherein the engine comprises a low power-output operating range, a high power-output operating range and an idle operating range, and the expander controller selects the active mode when the engine is in the low power-output operating range.

19. The engine system of claim 13 or 17, wherein the engine comprises a low power-output operating range, a high power-output operating range and an idle operating range, and the expander controller selects the active mode when the engine is transitioning from the idle operating range to the low power-output operating range.

20. The engine system of claim 13 or 17, wherein the variable valve timing controller is configured to implement cylinder deactivation by deactivating the respective intake valve and the respective exhaust valve for at least one of the plurality of combustion cylinders while completing the combustion cycle for the remainder of the plurality of combustion cylinders, and wherein the expander controller is configured to select the active mode when the variable valve timing controller implements cylinder deactivation.

21. The engine system of claim 13, further comprising an exhaust gas recirculation controller for receiving exhaust from the engine, and coupled to return exhaust gas to the engine intake manifold.

22. The engine system of claim 13, further comprising an exhaust gas recirculation controller for receiving exhaust from the expander, and coupled to return exhaust gas to the engine intake manifold.

23. The engine system of claim 13, further comprising an intake assist device comprising one of an electrically assisted variable speed (“EAVS”) supercharger, an electric boosting device, a centrifugal compressor with an electric motor, a Roots, screw or scroll type supercharger, or an electrically assisted device with a planetary gear,

24. The engine system of claim 23, further comprising an exhaust gas recirculation controller for receiving exhaust from the engine, and coupled to return exhaust gas upstream of the intake valve, and downstream from the intake assist device.

25. The engine system of claim 23, further comprising an exhaust gas recirculation controller for receiving exhaust from the engine, and coupled to return exhaust gas upstream of the intake assist device.

26. The engine system of claim 23, further comprising an exhaust gas recirculation controller for receiving exhaust from the expander, and coupled to return exhaust gas upstream of the intake valve, and downstream from the intake assist device.

27. The engine system of claim 23, further comprising an exhaust gas recirculation controller for receiving exhaust from the expander, and coupled to return exhaust gas upstream of the intake assist device.

28. The engine system of one of claims 23 to 27, further comprising a turbocharger, wherein the turbocharger receives exhaust gas from the engine prior to the exhaust gas recirculation controller.

29. A method of controlling an engine system, the engine system comprising:
an engine comprising an inlet manifold, an exhaust manifold, and a plurality of combustion cylinders, and each of the plurality of combustion cylinders is connected to receive air from the inlet manifold and to expel exhaust from the exhaust manifold;
a respective intake valve for regulating air flow from the inlet manifold in to a respective one of each of the plurality of combustion cylinders;
a respective exhaust valve for regulating exhaust flow from a respective one of each of the plurality of combustion cylinders in to the exhaust manifold;
a respective piston in each of the plurality of combustion cylinders, each respective piston connected to the engine to travel in its respective cylinder from top dead center to bottom dead center to complete a combustion cycle;
a variable valve timing controller connected to the respective intake valves and to the respective exhaust valves to control the timing of each of the plurality of combustion cylinders for receiving air from the inlet manifold and to control the timing for each of the plurality of combustion cylinders for expelling exhaust to the exhaust manifold;
a fuel injection system connected to supply fuel to each of the plurality of combustion cylinders;
a expander connected to receive exhaust from the exhaust manifold;
a motor/generator connected to power the expander; and
an expander controller connected to control the motor/generator connection to the expander,
and the method comprises controlling the expander controller to select between a passive mode, where exhaust passively moves through the expander, and an active mode, where the motor/generator powers the expander to actively draw exhaust from the exhaust manifold.

30. The method of claim 29, wherein the engine system further comprises a turbocharger, and the method further comprises exhausting exhaust from the expander to the turbocharger to power the turbocharger to supply boosted air to the inlet manifold.

31. The method of claim 29, further comprising selecting the passive mode and charging the motor/generator via the expander.

32. The method of claim 29, wherein the combustion cycle comprises at least an intake stroke, a compression stroke, a combustion stroke and an exhaust stroke, and the method further comprises controlling the variable valve timing controller to close at least one intake valve and at least one exhaust valve for at least one of the plurality of combustion cylinders from bottom dead center to top dead center of the compression stroke, and from top dead center to bottom dead center of the combustion stroke.

33. The method of claim 29 or 32, wherein the engine comprises a low power-output operating range, a high power-output operating range and an idle operating range, and the method comprises selecting the active mode when the engine is in the low power-output operating range.

34. The method of claim 29 or 32, wherein the engine comprises a low power-output operating range, a high power-output operating range and an idle operating range, and the method comprises selecting the active mode when the engine is transitioning from the idle operating range to the low power-output operating range.

35. The method of claim 29 or 32, further comprising:
implementing cylinder deactivation by deactivating the respective intake valve and the respective exhaust valve for at least one of the plurality of combustion cylinders while completing the combustion cycle for the remainder of the plurality of combustion cylinders, and
selecting the active mode.

36. The method of claim 29, wherein the engine further comprises an intake assist device and the method further comprises controlling the intake assist device to provide charge air to the intake valve, and timing the intake valve and the exhaust valve independently to optimize the air content of the cylinder for a given load to the engine.

37. The method of claim 29, further comprising timing the exhaust valve to open for exhausting exhaust once the piston reaches bottom dead center after a combustion cycle.

38. The method of claim 29, further comprising controlling an intake assist device to increase compression of intake air to the combustion cylinder, the intake assist device comprising one of an electrically assisted variable speed (“EAVS”) supercharger, an electric boosting device, a centrifugal compressor with an electric motor, a Roots, screw or scroll type supercharger, or an electrically assisted device with a planetary gear,

39. The method of claim 38, further comprising controlling an exhaust gas recirculation controller to receive exhaust from the engine and to return exhaust gas upstream of the intake valve and downstream from the intake assist device.

40. The method of claim 38, further comprising controlling an exhaust gas recirculation controller to receive exhaust from the engine and to return exhaust gas upstream of the intake assist device.

41. The method of claim 38, further comprising controlling an exhaust gas recirculation controller to receive exhaust from the expander to return exhaust gas upstream of the intake valve and downstream from the intake assist device.

42. The method of claim 38, further comprising controlling an exhaust gas recirculation controller to receive exhaust from the expander and to return exhaust gas upstream of the intake assist device.

43. The method of one of claims 38 to 42, further comprising controlling a turbocharger to receive exhaust gas from the engine prior to the exhaust gas recirculation controller.

44. The method of claim 38, further comprising selecting the active mode and controlling the intake assist device to provide boosted intake air.

45. The method of claim 44, further comprising controlling the timing of the intake valve independently of the timing for the exhaust valve.

46. The method of claim 38, further comprising controlling the intake assist device to control intake air pressure at the intake valve, and controlling the expander to control exhaust pressure at the exhaust valve.

47. The method of claim 29, further comprising controlling the expander to control exhaust pressure at the exhaust valve.
